(19) United States
(12) Patent Application Publication
(10) Pub. No.: US 2004/0181589 A1
(43) Pub. Date: Sep. 16, 2004

(54) Storage virtual channels and method for using the same

(75) Inventor: Yaser I. Suleiman, Santa Clara, CA (US)

Correspondence Address: MARTINE & PENILLA, LLP, 710 LAKEWAY DRIVE, SUITE 170, SUNNYVALE, CA, 94085, US

(73) Assignee: Sun Microsystems,Inc., Santa Clara, CA

(21) Appl. No.: 10/390,306

(22) Filed: Mar. 14, 2003

(51) Int. Cl. G06F 13/00

(52) U.S. Cl. 709/213; 711/114

(57) ABSTRACT

A process and a method is provided to allow clients of a shared storage resource to have differentiated and protected access to the shared storage resource. More specifically, a total bandwidth capability of the storage resource is divided among a number of storage virtual channels. Each storage virtual channel is defined to accommodate an associated client's workload involving storage resource access. The storage virtual channels ensure that each client continuously receives differentiated, adequate, and protected access to the shared storage resource.

### CROSS REFERENCE TO RELATED APPLICATIONS

This application is related to U.S. patent application Ser. No. ______ (Attorney Docket No. SUNMP237), filed on even date herewith, and entitled “Methods for Assigning Performance Specifications to a Storage Virtual Channel.” The disclosure of this related application is incorporated herein by reference.

### BACKGROUND OF THE INVENTION

1. Field of the Invention

The present invention relates generally to computer storage systems, and more particularly, to a process and a method for facilitating the sharing of a common storage resource and its bandwidth among a number of client computer platforms.

2. Description of the Related Art

An increase in single storage system capacity, as disk drive capacity is being periodically increased, enhances the ability of a fewer number of storage systems to simultaneously support the needs of different applications executing across numerous client computing platforms (“clients”). In following, Storage Area Networks (SANs) are increasingly being deployed, wherein a single storage system is tasked to provide services to multiple clients. As a result, the resources of the single storage system are increasingly becoming shared concurrently among all of its active clients. The resources of the single storage system are typically orchestrated in a fashion which maximizes the aggregate utilization of the storage system, with little or no regard to the specific needs of its individual clients.

In the current situation in which multiple clients access a single storage device, the storage devices, storage networks, and host input/output (“IO”) driver stacks all treat IO requests originating from different clients on the basis of first-come-first-serve sharing. Thus, all IO requests received by the storage device are processed in the order in which they arrive at the storage device. Hence, there is no differentiation between the clients when accessing the storage device. Also, there is no access protection afforded to the various clients accessing the storage device.

The lack of differentiation between clients when accessing the single storage device can cause problems for clients that require different performance characteristics from the storage device. For example, streaming and multimedia applications often require a steady rate of large data transmissions. Conversely, direct data accounting tends to have more random transmissions of smaller amounts of data and requires a fast response time. Other applications like file systems, databases, snapshot, and mirroring also have their own storage performance needs. Therefore, since the current storage systems lack an ability to differentiate between clients and their respective application needs, a high probability exists that at least some of a diverse group of clients will not be properly serviced by the storage device.

The lack of access protection afforded to the various clients can lead to a domination of storage device access by some clients at the expense of storage device access of other clients. Correspondingly, if a first client has an ability to generate IO requests faster than a second client, a potential exists for the first client to dominate the IO bandwidth of the storage device and drive the second client to near IO starvation. Thus, unconstrained storage resource allocations to some clients can result in unexpected degraded service to other clients. Consequently, the storage system needs to control the allocation of its resources in a manner that will protect its expected performance to the various clients.

Storage consolidation into large pools, capable of concurrently serving a larger client community, is becoming more popular through the deployment of SAN environments. In the future, it is expected that more clients will be sharing access, and in some cases competing for access, to a common storage resource. Thus, as storage resources are expected to serve a larger set of applications and clients there is an emerging need for these systems to provide new functionality in the areas of client differentiation and client access protection.

In view of the foregoing, there is a need for a process and a method that will support differentiated and protected performance characteristics between clients and a shared storage resource. More specifically, there is a need for a process and a method for providing differentiated levels of service to various clients from a shared storage resource based on the various client's needs. Additionally, there is a need for a process and a method to protect a level of service contracted to or expected by a client from being adversely impacted by concurrent loads placed on the storage resource by other clients.

### SUMMARY OF THE INVENTION

Broadly speaking, the present invention fills these needs by providing a process and a method that allows clients to have differentiated and protected access to a shared storage resource. More specifically, the present invention divides a total bandwidth capability of a storage resource among a number of storage virtual channels (SVCs). Each SVC can serve one or more clients requiring access to the storage resource. Each SVC is defined to accommodate an associated client's storage resource access needs. The assignment of a SVC to a client is based on a bandwidth capability of the SVC, a bandwidth need of the client, and a bandwidth privilege level of the client. The SVCs ensure that each client continuously receives differentiated, adequate, and protected access to the shared storage resource.

In one embodiment, a computer implemented process for managing bandwidth access of a storage resource is disclosed. The process includes determining a total bandwidth capability for the storage resource. A set of SVCs are then defined by assigning a portion of the total bandwidth capability of the storage resource to each SVC. The process further includes assigning the SVCs to clients requesting access to the storage resource.

In another embodiment, a computer implemented process for dynamic bandwidth access management of a storage resource is disclosed. The process includes determining a total bandwidth capability for the storage resource. The process also includes detecting requests from clients desiring access to the storage resource. A privilege level for each of the clients desiring access is determined. The process further includes defining SVCs to serve the clients desiring access. The SVCs have a portion of the total bandwidth capability of the storage resource commensurate with the privilege level of the clients to be served. The process also includes assigning the defined SVCs to serve the appropriate clients such that the clients are provided with an entitled portion of the total bandwidth capability during access to the storage resource.

In another embodiment, a method for defining a storage virtual channel is disclosed. The method includes determining a total bandwidth of a storage resource of a storage area network. The total bandwidth of the storage resource is divided into a number of smaller bandwidths. Each of the number of smaller bandwidths represents a storage virtual channel. The method further includes assigning control specifications to each storage virtual channel. The control specifications include throughput and response time control specifications.

In another embodiment, a method for using a storage virtual channel is disclosed. The method includes assigning a storage virtual channel to a client of a storage area network. The storage virtual channel serves as a dedicated and protected communication link between the client and a storage resource of the storage area network. The method also includes sending an access request from the client to the storage resource using the storage virtual channel. The storage resource receives the access request from the client and provides the client with access to the storage resource in accordance with specifications of the storage virtual channel.

Other aspects of the invention will become more apparent from the following detailed description, taken in conjunction with the accompanying drawings, illustrating by way of example the present invention.

### BRIEF DESCRIPTION OF THE DRAWINGS

The invention, together with further advantages thereof, may best be understood by reference to the following description taken in conjunction with the accompanying drawings in which:

FIG. 1 is an illustration showing a storage area network (SAN), in accordance with one embodiment of the present invention;

FIG. 2 is an illustration showing a storage resource in communication with a SAN, in accordance with one embodiment of the present invention;

FIG. 3A is an illustration depicting a storage resource having a number of ports, wherein each port has a dedicated SVC, in accordance with one embodiment of the present invention;

FIG. 3B is an illustration depicting a storage resource having a number of ports, wherein a port can be used by multiple SVCs or a port can be dedicated to a single SVC, in accordance with one embodiment of the present invention;

FIG. 3C is an illustration depicting a storage resource having a number of LUNs, wherein a LUN can be used by multiple SVCs or a LUN can be dedicated to a single SVC, in accordance with one embodiment of the present invention;

FIG. 4 is an illustration depicting a number of clients communicating with a storage resource through a number of SVCs, in accordance with one embodiment of the present invention;

FIG. 5 is an illustration depicting a functional model of a RAID based storage resource implementing SVCs, in accordance with one embodiment of the present invention;

FIG. 6 shows a flowchart illustrating a method for defining a SVC, in accordance with one embodiment of the present invention;

FIG. 7 shows a flowchart illustrating a method for using a SVC, in accordance with one embodiment of the present invention;

FIG. 8 shows a flowchart illustrating a computer implemented process for managing bandwidth access of a storage resource, in accordance with one embodiment of the present invention; and

FIG. 9 shows a flowchart illustrating a computer implemented process for dynamic bandwidth access management of a storage resource, in accordance with one embodiment of the present invention.

### DETAILED DESCRIPTION OF THE PREFERRED EMBODIMENTS

Broadly speaking, an invention is disclosed for a process and a method that allows clients to have differentiated and protected access to a shared storage resource. More specifically, the present invention divides a total bandwidth capability of a storage resource among a number of storage virtual channels. Each storage virtual channel can serve one or more clients requiring access to the storage resource. Each storage virtual channel is defined to accommodate an associated client's storage resource access needs. The assignment of a storage virtual channel to a client can be based on several factors including, but not limited to, a bandwidth capability of the storage virtual channel, a bandwidth need of the client, and a bandwidth privilege level of the client. The storage virtual channels ensure that each client continuously receives differentiated, adequate, and protected access to the shared storage resource. It should be appreciated that the present invention can be implemented in numerous ways, including as a process, an apparatus, a system, a device, or a method. Several exemplary embodiments of the invention will now be described in detail with reference to the accompanying drawings.

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

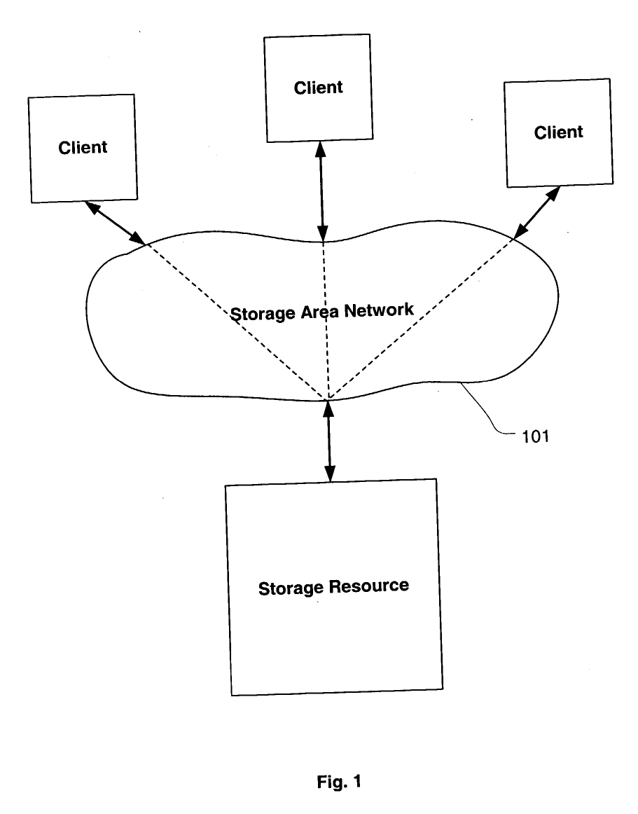

FIG. 1 is an illustration showing a storage area network (SAN) 101, in accordance with one embodiment of the present invention. The SAN 101 includes at least one client in communication with a storage resource using input/output (IO) requests. The term “clients” means any entity with an associated IO workload, such as an application, a set of applications within one or more computer host systems, one or more ports of a client, and single or multiple clients. The storage resource includes one or more storage devices capable of storing data suitable for use by a client.

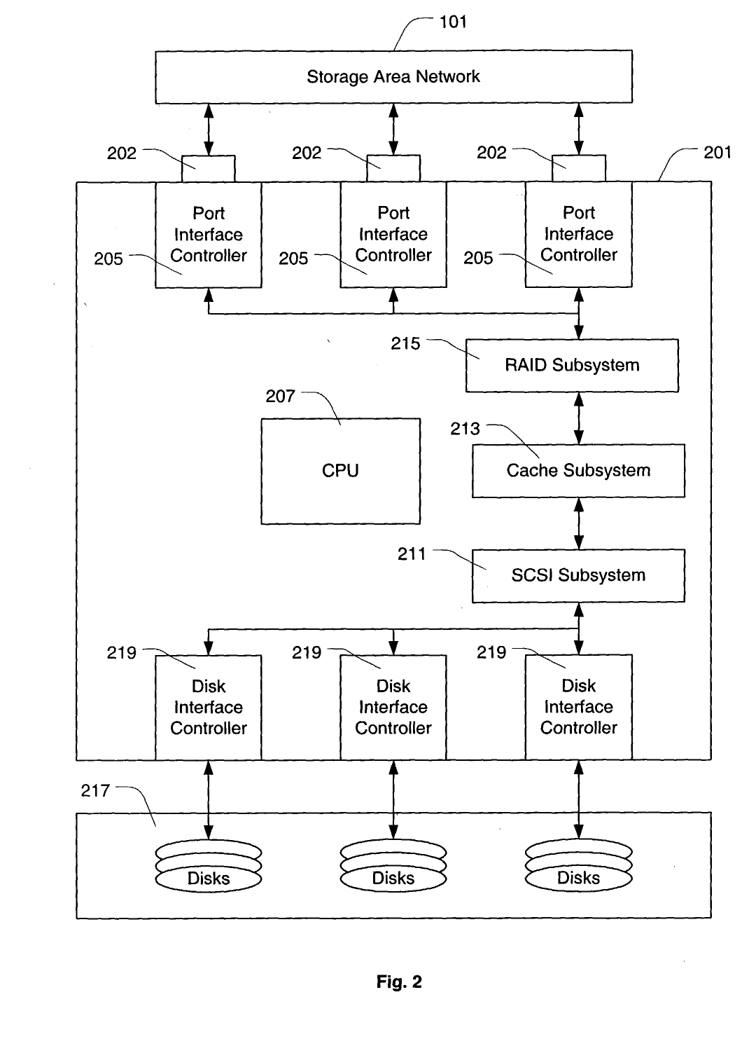

FIG. 2 is an illustration showing a storage resource 201 in communication with a SAN 101, in accordance with one embodiment of the present invention. The storage resource 201 can include one or more ports 202 through which communication with the clients of the SAN 101 is established. Each port has an associated port interface controller 205. The storage resource 201 includes a SCSI subsystem 211 for decoding and encoding IO requests from and responses to the clients of the SAN 101. A cache subsystem 213 is also provided for fast retrieval and copying of data. A RAID subsystem 215 is provided to orchestrate an array of disks 217. A number of disk interface controllers 219 are provided for interfacing with the array of disks 217. The data path flow through the storage resource 201 includes the port interface controller 205, the SCSI subsystem 211, the cache subsystem 213, the RAID subsystem 215, the disk interface controller 219, and the array of disks 217. The storage resource 201 also includes a CPU 207. The CPU 207 is used to control the operations of the storage resource 201.

Generally speaking, the clients can transmit data to the storage resource and receive data from the storage resource. Communication between the clients and the storage resource is governed by a bandwidth of the storage resource. The total bandwidth of the storage resource is defined by a throughput capability and a response time capability. The throughput capability is characterized in terms of a data rate (MB/sec) and an IO request processing rate (IO/sec). The response time capability, also referred to as latency, is the average amount of time required for the storage resource to respond to a client's request.

The total bandwidth capability of a storage resource can be divided into a number of smaller bandwidths, wherein each smaller bandwidth is assigned to a storage virtual channel (SVC). Each SVC can be independently controlled to provide clients with differentiated and protected access to the storage resource. In this manner, an SVC can be used to supply a specific storage performance level (i.e., throughput and response time) to a client to which the SVC is assigned. Additionally, the specific storage performance level supplied by an SVC is protected from degradation that may be caused by other SVC workloads. Thus, the SVC provides a mechanism for sharing the resources of a single storage system concurrently between multiple clients, wherein each client receives protected and expected performance from the storage system.

The creation of SVCs can be performed either manually or automatically based on a preset policy. SVCs are defined to accommodate various aspects of the client's privilege level and bandwidth requirements. SVCs can be set to guarantee minimum bandwidth, and/or to limit the maximum bandwidth based on the client privilege level. The client bandwidth need and client privilege level can be characterized in terms of MB/sec, IO/sec, response time, and any combination thereof. Each SVC is dynamic in the sense that each SVC can be created, modified, and destroyed as needed. In one embodiment, SVCs are destroyed when no longer needed, thus freeing up their bandwidth for use by other existing SVCs. For example, an SVC may be created for a client when the client is present in the SAN. However, when the client leaves the SAN or is no longer in communication with the SAN, the corresponding SVC bandwidth can be reconstituted into the free bandwidth available for use by other SVCs.

Each SVC is independently assigned to serve one or more clients. In one embodiment, the assignment of SVCs to clients is based on a policy set by an administrator. The policy can consider pertinent factors such as client bandwidth need, client privilege level, and bandwidth afforded by the SVC. In another embodiment, SVCs may be assigned or reassigned based on performance levels. For example, if an SVC is assigned to one client that only uses a small portion of the bandwidth afforded by the SVC. The SVC may also be assigned to another client having a commensurate client bandwidth need and client privilege level. In addition to being assigned to external clients, each SVC can also be assigned to internal entities such as a port of the storage resource or a logical unit number (LUN) of the storage resource. In this instance, any client using the port or accessing the LUN will be served by the SVC assigned to the respective port or LUN.

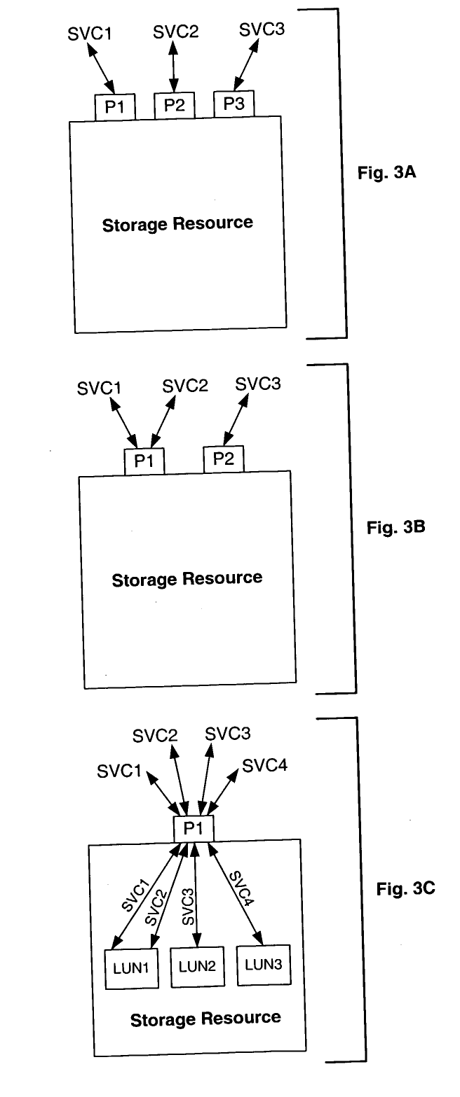

FIG. 3A is an illustration depicting a storage resource having a number of ports, wherein each port has a dedicated SVC, in accordance with one embodiment of the present invention. The storage resource is shown as having ports P1, P2, and P3. SVCs SVC1, SVC2, and SVC3 use ports P1, P2, and P3, respectively.

FIG. 3B is an illustration depicting a storage resource having a number of ports, wherein a port can be used by multiple SVCs or a port can be dedicated to a single SVC, in accordance with one embodiment of the present invention. The storage resource is shown as having ports P1 and P2. SVC1 and SVC2 use port P1, and SVC3 uses port P2.

FIG. 3C is an illustration depicting a storage resource having a number of LUNs, wherein a LUN can be used by multiple SVCs or a LUN can be dedicated to a single SVC, in accordance with one embodiment of the present invention. SVC1, SVC2, SVC3, and SVC4 share port P1. However, SVC1 and SVC2 are assigned to LUN1 while SVC3 and SVC4 are assigned to LUN2 and LUN3, respectively.

The embodiments depicted in FIGS. 3A through 3C are provided for exemplary purposes. Other embodiments can include different numbers of SVCs, ports, and LUNs. Furthermore, other embodiments can have the various SVCs assigned to the ports and LUNs in different ways.

Differentiated performance levels are provided to the different clients by assigning an SVC having appropriate specifications to each client. Determination of an appropriate SVC specification for a client can be based on a privilege level associated with the client. The client privilege level can be characterized by a required minimum throughput and/or a maximum allowable response time.

Assignment of an SVC to a client is a flexible operation. For example, an SVC can be assigned to a single client to serve only the storage workload of that client. Alternatively, an SVC can be assigned to multiple clients to serve the storage workloads of the multiple clients. If an SVC is exclusively assigned to a client, the bandwidth afforded by the SVC can be expected by the client. If multiple clients share an SVC, the bandwidth afforded by the SVC is distributed among the storage workloads of the multiple clients. In one embodiment, multiple clients sharing the SVC will compete on a first-come-first-serve basis. Consequently in this embodiment, multiple clients sharing the SVC may experience fluctuations in their storage performance based on other client storage workload variations. In another embodiment, the bandwidth afforded by the SVC can be sub-divided in a hierarchical manner to create sub-SVCs capable of serving the multiple clients. In this embodiment, each of the multiple clients will be guaranteed a storage performance corresponding to the characteristics of the assigned sub-SVC.

In addition to being assigned independently, each SVC can also be independently controlled. Since each SVC is defined in terms of the bandwidth parameters throughput and response time, it follows that each SVC can be controlled in terms of throughput and response time. For example, an SVC can be controlled to operate within ranges extending from minimum MB/sec, minimum IO/sec, and minimum response time to maximum MB/sec, maximum IO/sec, and maximum response time, respectively.

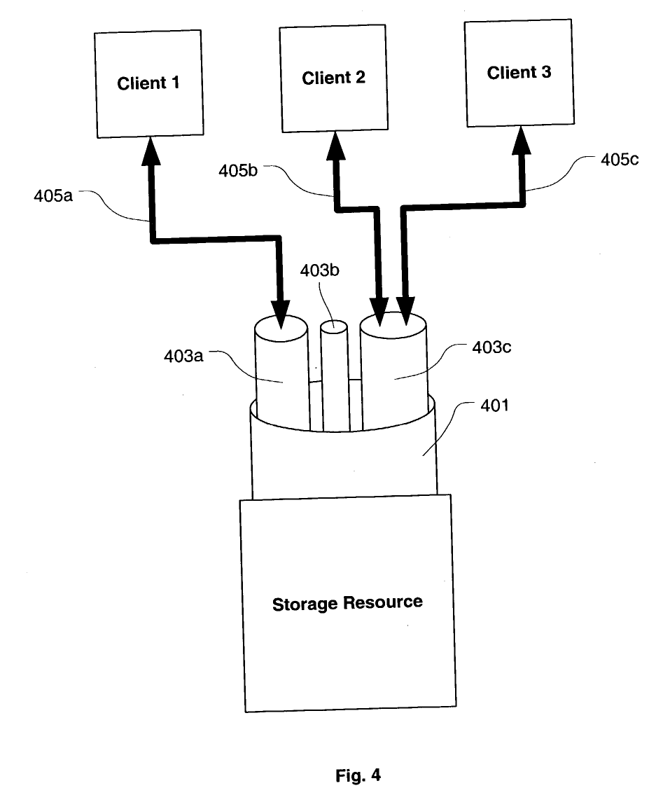

FIG. 4 is an illustration depicting a number of clients communicating with a storage resource through a number of SVCs, in accordance with one embodiment of the present invention. For exemplary purposes, three clients, Client 1, Client 2, and Client 3, are shown communicating with the storage resource through two of three SVCs, 403a, 403b, and 403c. SVCs 403a, 403b, and 403c each represent a portion of the total bandwidth 401 offered by the storage resource. Communication, as indicated by arrow 405a, is established between Client 1 and the storage resource through SVC 403a. Also, communications, as indicated by arrows 405b and 405c, are established between Client 2 and Client 3, respectively, and the storage resource through SVC 403c. In one embodiment, since both Client 2 and Client 3 share SVC 403c, Client 2 and Client 3 operate on a first-come-first-serve basis with respect to the bandwidth offered by SVC 403c. In the example of FIG. 4, SVC 403b is not connected to a client. In one embodiment SVC 403b may be held in reserve for future use as needed. In another embodiment, SVC 403b may be dedicated to a particular client that is not currently present.

Each SVC provides its assigned clients with a minimum guaranteed storage resource bandwidth. Thus, each SVC protects its assigned clients from being adversely impacted by concurrent loads placed on the storage resource by other clients. In order to provide the minimum guaranteed storage resource bandwidth, the various SVCs are allowed to limit their clients to a maximum storage resource bandwidth. The maximum storage resource bandwidth of an SVC must be at least as large as the minimum storage resource bandwidth guaranteed by the SVC. However, the maximum storage resource bandwidth of each SVC can be limited to allow all SVCs to provide at least the minimum storage resource bandwidth guaranteed to their clients.

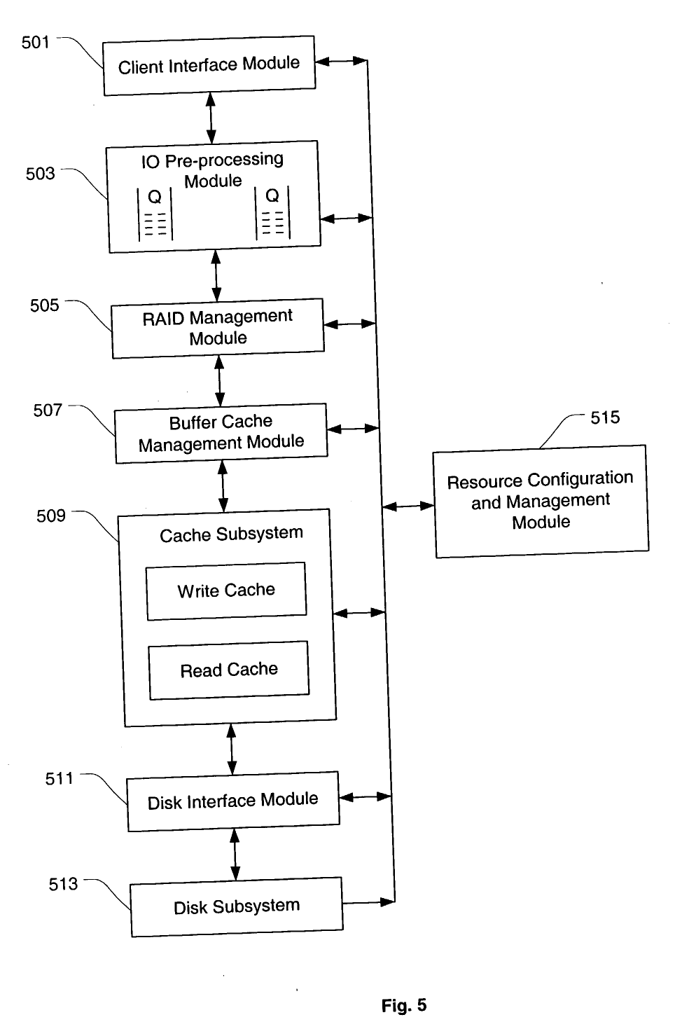

SVCs can be implemented in a variety of storage systems which utilize modern storage interface protocols. For exemplary purposes only, a discussion of SVC implementation in a RAID based storage resource using a SCSI protocol is provided below. FIG. 5 is an illustration depicting a functional model of a RAID based storage resource implementing SVCs, in accordance with one embodiment of the present invention. A client interface module 501 is provided to receive a data transfer command from a client, implement a protocol engine, extract a storage system command, and pass the storage system command to a IO pre-processing module 503. SCSI (small computer system interface) is the protocol engine of many current storage systems. SCSI is a block IO standard which incorporates both a set of protocols for the exchange of block IO data between clients and storage resources, and a parallel bus architecture. In addition, the present invention applies to other kinds of SCSI transports such as Fibre Channel (FCP) and TCP/IP iSCSI. In SCSI, the client invokes the IO commands, and the storage resource is responsible for directing movements of block data. Thus, whenever the client sends a SCSI command to the storage resource requesting data, the client waits while the storage resource processes the command. In following, the SCSI protocol allows clients to queue multiple commands. However, the SCSI protocol does not dictate a specific queuing technique. The specific queuing technique must be implemented within the storage resource. Though this example of SVC implementation is presented in terms of a SCSI protocol and a RAID based storage system, it should be appreciated that SVCs can be implemented with any storage system using any storage interface protocol suitable for use in a SAN environment.

Upon receipt of the command in the IO pre-processing module 503, the command is queued and decoded for further processing. A first level of SVC implementation can be provided in the IO pre-processing module 503. For example, each SVC can be assigned to a separate queue. Thus, all commands received through a given SVC will be stacked in a given queue. Each queue can then be weighted based on the SVC specifications of throughput and response time. In this manner, commands can be scheduled for processing from the various queues in a sequence that preserves the storage resource bandwidth guaranteed by the various SVCs to their respective clients. Hence, with SVC implementation, the queues in the IO pre-processing module 503 can be referred to as scheduling queues. In one embodiment, the various scheduling queues can be created by firmware of the storage resource. In following, the weighting of the scheduling queues and the orchestration of command processing from the various scheduling queues can be controlled using a scheduling algorithm that controls the corresponding firmware of the storage resource. In one embodiment, each of the scheduling queues can be represented as a separate portion of cache. Thus, each SVC can be assigned to a separate cache that is created by the storage resource firmware.

Once an appropriate command is selected from the various scheduling queues according to the scheduling algorithm, the RAID management module 505 is responsible for decomposing the command into one or more stripe operations. Each stripe operation specifies a set of IO operations to be performed on either the disk subsystem and/or cache buffer corresponding to the stripe. In one possible SVC implementation, the RAID management module 505 can optionally be configured to have a separate cache corresponding to each scheduling queue (i.e., a SVC). The stripe operations can be queued into the cache corresponding the scheduling queue from which their originating command was received. A cache selector can then be employed to direct the sequence in which stripe operation will be selected for execution from the various caches. The cache selector can operate based on an algorithm similar to that used for the scheduling algorithm in the IO pre-processing module 503. In this manner, the cache and cache selector within the RAID management module 505 can act a second level of SVC implementation to provide redundancy in ensuring that the storage resource bandwidth guaranteed by the various SVCs is provided to their respective clients.

Once the cache selector selects a stripe operation to be executed, the stripe operation is processed through the remaining standard functional modules of the RAID based storage resource including a buffer cache management module 507, a cache subsystem 509, a disk interface module 511, and the disk subsystem 513. Generally speaking, the buffer cache management module 507 is responsible for allocating buffers and orchestrating the cache allocation and replacement policy within the cache subsystem 509. The cache subsystem 509 contains a write cache and a read cache. From the cache subsystem 509 the various stripe operations are passed to the disk interface module 511 where a set of corresponding disk commands is generated. A disk command is simply a SCSI read or SCSI write for an amount of data in one stripe unit. The disk commands are passed from the disk interface module 511 to the disk subsystem 513 where they are ultimately executed. Data resulting from execution of the disk commands is then transferred between the cache subsystem 509 and the disk subsystem 513.

The functional model of the RAID based storage resource implementing SVCs also includes a resource configuration and management module 515. The resource configuration and management module 515 traditionally handles tasks such as configuration and management of volumes, LUNs, read cache size, write cache size, and stripe size. However, with implementation of SVCs, the resource configuration and management module 515 can also be used to implement the scheduling and cache selector algorithms.

Thus, in accordance with the example above, the SVCs can be enforced at a first level using scheduling queues and a scheduling algorithm, wherein each SVC is assigned to a separate scheduling queue. The scheduling algorithm is used to control the sequence in which commands contained within the scheduling queues are processed. The scheduling algorithm operates based on weightings of the various scheduling queues. The weightings of the various scheduling queues are a function of the corresponding SVC specifications of throughput and response time. The SVCs can be further enforced at a second level using multiple caches and a cache selector, wherein each of the multiple caches corresponds to a scheduling queue (i.e., SVC). In a manner similar to the scheduling algorithm, the cache selector is used to control the sequence in which stripe operations contained within the caches are further processed. Hence, in one embodiment SVCs can be implemented using techniques of multiple scheduling queues, a scheduling algorithm, multiple caches, and a cache selector. It should be understood, however, that SVC implementation is not limited to the aforementioned techniques.

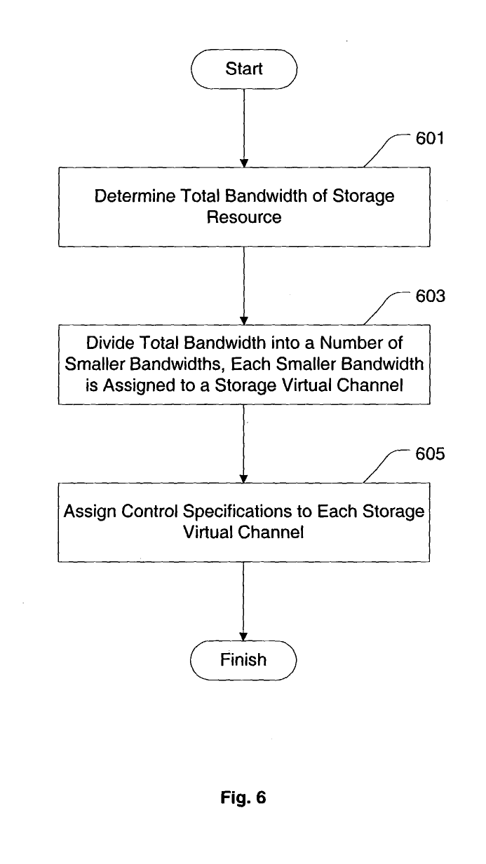

FIG. 6 shows a flowchart illustrating a method for defining a SVC, in accordance with one embodiment of the present invention. The method includes an operation 601 in which a total bandwidth of a storage resource operating in a SAN is determined. The total bandwidth of the storage resource is defined by its throughput capability and a response time capability. Also, the SAN includes one or more clients in communication with the storage resource, wherein each of the clients is an entity having an associated IO workload. The method continues with an operation 603 in which the total bandwidth of the storage resource is divided into a number of smaller bandwidths. Each of the smaller bandwidths is assigned to a SVC. The method also includes an operation 605 in which SVC control specifications are assigned. The SVC control specifications include throughput and response time control specifications.

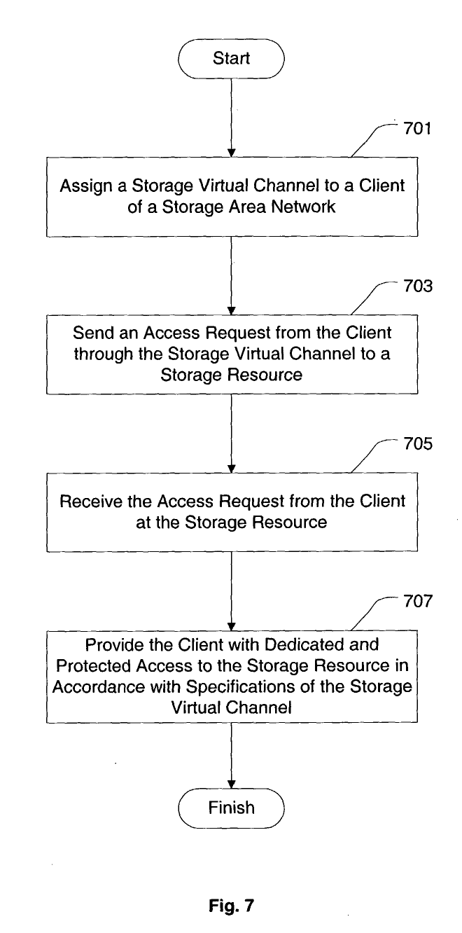

FIG. 7 shows a flowchart illustrating a method for using a SVC, in accordance with one embodiment of the present invention. The method includes an operation 701 in which a SVC is assigned to a client of a SAN. The SVC serves as a dedicated and protected communication link between the client and a storage resource of the SAN. The client to which the SVC is assigned has a client privilege level commensurate with specifications of the SVC. Since the specifications of the SVC include guarantees of a minimum throughput and a maximum response time, the privilege level is defined by an allowable minimum throughput and an allowable maximum response time. To ensure that one SVC does not dominate over other SVCs with respect to storage resource utilization, each SVC may also include a maximum throughput specification. The method further includes an operation 703 in which an access request is sent from the client to the storage resource using the SVC. The method continues with an operation 705 in which the access request is received through the SVC at the storage resource. The method also includes an operation 707 in which the client is provided with dedicated and protected access to the storage resource in response to the access request and in accordance with specifications of the SVC. The client to which the SVC is assigned is continuously provided with access to the storage resource in accordance with the specifications of the SVC. Additionally, if the client is removed from the SAN, a SVC assigned solely to the removed client can be eliminated. In following, the eliminated SVC bandwidth specifications can be reconstituted into other SVCs.

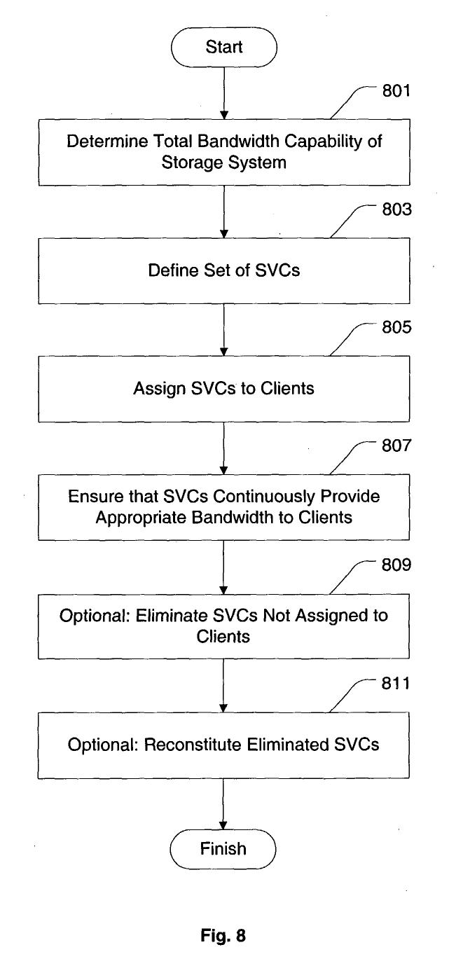

FIG. 8 shows a flowchart illustrating a computer implemented process for managing bandwidth access of a storage resource, in accordance with one embodiment of the present invention. The process includes an operation 801 in which a total bandwidth capability for the storage resource is determined. The total bandwidth capability is defined by a throughput capability and a response time capability. The process also includes an operation 803 in which a set of SVCs is defined. Each SVC is assigned a portion of the total bandwidth capability determined for the storage resource. Additionally, each SVC may be defined based on a client bandwidth need and a client privilege level, wherein a client is an entity having an associated IO workload. The client privilege level is defined by an allowable minimum throughput and an allowable maximum response time. The process further includes an operation 805 in which the SVCs are assigned to serve the needs of clients requesting access to the storage resource. In one embodiment, assignment of SVCs to clients is based on a predefined policy, wherein the predefined policy considers the privilege level of each client. In an operation 807, the process ensures that the SVCs continuously provide the assigned portion of the total bandwidth capability to the clients to which the SVCs are assigned. In one embodiment, operation 807 may be performed by limiting a throughput capability of each of the SVCs such that no single SVC can dominate the storage resource. In an optional operation 809, the process provides for elimination of SVCs when not assigned to a client. The process further includes an operation 811 in which the portion of the total bandwidth capability assigned to an eliminated SVC is reconstituted to be reassigned to other SVCs.

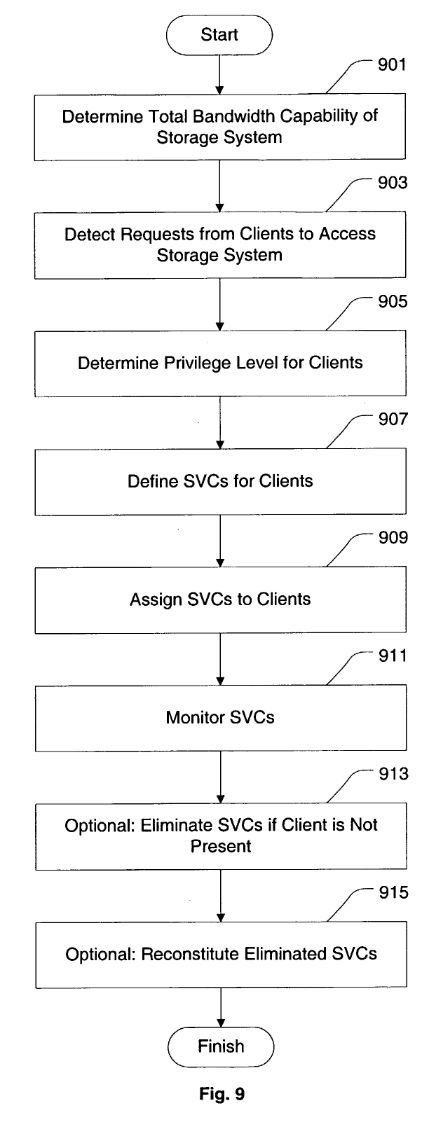

FIG. 9 shows a flowchart illustrating a computer implemented process for dynamic bandwidth access management of a storage resource, in accordance with one embodiment of the present invention. The process includes an operation 901 in which a total bandwidth capability for the storage resource is determined. The total bandwidth capability is defined by a throughput capability and a response time capability. In an operation 903, the process detects requests to access the storage resource. The requests are received from clients desiring access to the storage resource. In the process, any entity having an associated IO workload is considered a client. The process further includes an operation 905 in which a privilege level is determined for each client desiring access to the storage resource. The privilege level for each client is defined by an allowable minimum throughput and an allowable maximum response time. In an operation 907, the process defines an SVC for each client desiring access to the storage resource. Each SVC is defined to have a portion of the total bandwidth capability that is at least equivalent to the minimum throughput and maximum response time corresponding to the privilege level of a client to which the SVC will be associated. In an operation 909, the process assigns the defined SVCs to the clients so that each client is provided with an appropriate portion of the total bandwidth capability for use during access to the storage resource. The process continues with an operation 911 in which the portion of the total bandwidth capability available to each SVC is monitored to ensure that the appropriate portion of the total bandwidth capability is provided to each client in accordance with the client privilege level. The process also includes an optional operation 913 in which an SVC is eliminated when the last client to which the SVC is assigned is not present. In an operation 915, the process provides for reconstituting the portion of the total bandwidth capability associated with the eliminated SVC. The reconstituted portion of the total bandwidth capability is reassigned to one or more remaining SVCs.

While this invention has been described in terms of several embodiments, it will be appreciated that those skilled in the art upon reading the preceding specifications and studying the drawings will realize various alterations, additions, permutations and equivalents thereof. It is therefore intended that the present invention includes all such alterations, additions, permutations, and equivalents as fall within the true spirit and scope of the invention.

What is claimed is:

1. A computer implemented process for managing bandwidth access of a storage resource, comprising:
determining a total bandwidth capability for the storage resource;
defining a set of storage virtual channels, each of the set of storage virtual channels being assigned a portion of the total bandwidth capability; and
assigning storage virtual channels of the set of storage virtual channels to clients requesting access to the storage resource.

2. A computer implemented process for managing bandwidth access of a storage resource as recited in claim 1, wherein the total bandwidth capability is defined by a throughput capability and a response time capability, the throughput capability including a data rate capability and an input/output rate capability.

3. A computer implemented process for managing bandwidth access of a storage resource as recited in claim 1, wherein each of the clients is an entity having an associated input/output workload.

4. A computer implemented process for managing bandwidth access of a storage resource as recited in claim 1, wherein each of the set of storage virtual channels is defined based on a client bandwidth need and a client privilege level.

5. A computer implemented process for managing bandwidth access of a storage resource as recited in claim 4, wherein the client privilege level is defined by an allowable minimum throughput and an allowable maximum response time.

6. A computer implemented process for managing bandwidth access of a storage resource as recited in claim 1, further comprising:
ensuring that the storage virtual channels continuously provide the respective assigned portion of the total bandwidth capability to the clients to which the storage virtual channels are assigned.

7. A computer implemented process for managing bandwidth access of a storage resource as recited in claim 6, wherein the ensuring includes limiting a throughput capability of each of the storage virtual channels.

8. A computer implemented process for managing bandwidth access of a storage resource as recited in claim 1, wherein each storage virtual channel is assigned to a single client.

9. A computer implemented process for managing bandwidth access of a storage resource as recited in claim 1, wherein the assigning of storage virtual channels to clients is based on a predefined policy, the predefined policy considering a privilege level of each of the clients.

10. A computer implemented process for managing bandwidth access of a storage resource as recited in claim 1, further comprising:
assigning one or more of the storage virtual channels to a logical unit number of the storage resource.

11. A computer implemented process for managing bandwidth access of a storage resource as recited in claim 1, wherein the storage resource contains queues for temporarily holding data to be transmitted through or received from the storage virtual channels.

12. A computer implemented process for managing bandwidth access of a storage resource as recited in claim 11, further comprising:
assigning storage virtual channels to the queues for temporarily holding data.

13. A computer implemented process for managing bandwidth access of a storage resource as recited in claim 11, wherein the queues are defined within a cache of the storage resource.

14. A computer implemented process for managing bandwidth access of a storage resource as recited in claim 11, wherein the queues are created and managed by firmware and software in the storage resource.

15. A computer implemented process for managing bandwidth access of a storage resource as recited in claim 1, further comprising:
assigning one or more of the storage virtual channels to a communication port of the storage resource.

16. A computer implemented process for managing bandwidth access of a storage resource as recited in claim 1, further comprising:
eliminating a storage virtual channel when the storage virtual channel is not assigned to a client.

17. A computer implemented process for managing bandwidth access of a storage resource as recited in claim 16, further comprising:
reconstituting the portion of the total bandwidth capability assigned to the eliminated storage virtual channel, wherein the reconstituted portion of the total bandwidth capability is reassigned to one of a remaining set of storage virtual channels and a new set of storage virtual channels.

18. A computer implemented process for managing bandwidth access of a storage resource as recited in claim 1, wherein the storage resource and the clients are part of a storage area network.

19. A computer implemented process for dynamic bandwidth access management of a storage resource, comprising:
determining a total bandwidth capability for the storage resource;
detecting requests to access the storage resource, the requests being received from clients desiring access to the storage resource;
determining a privilege level for each of the clients desiring access;
defining storage virtual channels for each of the clients desiring access, each storage virtual channel having a portion of the total bandwidth capability that is associated with the privilege level of the particular client; and
assigning the defined storage virtual channels to the clients so that each client is provided with the portion of the total bandwidth capability during access to the storage resource.

20. A computer implemented process for dynamic bandwidth access management of a storage resource as recited in claim 19, wherein the total bandwidth capability is defined by a throughput capability and a response time capability, the throughput capability including a data rate capability and an input/output rate capability.

21. A computer implemented process for dynamic bandwidth access management of a storage resource as recited in claim 19, wherein each of the clients is an entity having an associated input/output workload.

22. A computer implemented process for dynamic bandwidth access management of a storage resource as recited in claim 19, wherein the privilege level for each of the clients is defined by an allowable minimum throughput and an allowable maximum response time, the allowable minimum throughput including an allowable minimum data rate and an allowable minimum input/output rate.

23. A computer implemented process for dynamic bandwidth access management of a storage resource as recited in claim 19, further comprising:
monitoring the portion of the total bandwidth capability available to each storage virtual channel to ensure that the portion of the total bandwidth capability provided to each of the clients is in accordance with the privilege level of the particular client.

24. A computer implemented process for dynamic bandwidth access management of a storage resource as recited in claim 19, further comprising:
eliminating a storage virtual channel when the clients to which the storage virtual channel is assigned are not present.

25. A computer implemented process for dynamic bandwidth access management of a storage resource as recited in claim 24, further comprising:
reconstituting the portion of the total bandwidth capability associated with the eliminated storage virtual channel, wherein the reconstituted portion of the total bandwidth capability is reassigned to one of a remaining set of storage virtual channels and a new set of storage virtual channels.

26. A method for defining a storage virtual channel, comprising:
determining a total bandwidth of a storage resource of a storage area network;
dividing the total bandwidth into a number of smaller bandwidths, each of the number of smaller bandwidths being assigned to a storage virtual channel; and
assigning control specifications to each storage virtual channel, the control specifications including throughput and response time control specifications, wherein the throughput control specification includes a data rate control specification and an input/output rate control specification.

27. A method for defining a storage virtual channel as recited in claim 26, wherein the storage area network includes one or more clients in communication with the storage resource.

28. A method for defining a storage virtual channel as recited in claim 27, wherein each of the clients is an entity having an associated input/output workload.

29. A method for defining a storage virtual channel as recited in claim 27, further comprising:
assigning a storage virtual channel to one or more clients, each of the one or more clients having a client bandwidth need and a client privilege level that can be accommodated by the control specifications assigned to the storage virtual channel.

30. A method for defining a storage virtual channel as recited in claim 26, wherein the total bandwidth is defined by a throughput capability and a response time capability, the throughput capability being defined by a data rate capability and an input/output rate capability.

31. A method for using a storage virtual channel, comprising:
assigning a storage virtual channel to a client of a storage area network, the storage virtual channel being a dedicated and protected communication link between the client and a storage resource of the storage area network;
sending an input/output request from the client to the storage resource, the sending being performed using the storage virtual channel;
receiving the input/output request from the client at the storage resource; and
providing the client with access to the storage resource in accordance with specifications of the storage virtual channel.

32. A method for using a storage virtual channel as recited in claim 31, wherein the specifications of the storage virtual channel include a minimum throughput and a maximum response time.

33. A method for using a storage virtual channel as recited in claim 32, wherein the specifications of the storage virtual channel include a maximum throughput.

34. A method for using a storage virtual channel as recited in claim 31, wherein the storage virtual channel is assigned to a client having a privilege level that complies with specifications of the storage virtual channel, the privilege level being defined by an allowable minimum throughput and an allowable maximum response time, the allowable minimum throughput including an allowable minimum data rate and an allowable minimum input/output rate.

35. A method for using a storage virtual channel as recited in claim 31, further comprising:
ensuring that the client to which the storage virtual channel is assigned is continuously provided with access to the storage resource in accordance with the specifications of the storage virtual channel.

36. A method for using a storage virtual channel as recited in claim 35, wherein the ensuring includes limiting a throughput capability of other storage virtual channels, the throughput capability including a data rate capability and an input/output capability.

37. A method for using a storage virtual channel as recited in claim 31, further comprising:
eliminating the storage virtual channel when the client is removed from the storage area network.
